(19) United States
(12) Patent Application Publication
(10) Pub. No.: US 2011/0205894 A1
(43) Pub. Date: Aug. 25, 2011

(54) TRAFFIC SHAPING FOR REAL TIME MEDIA STREAMS

(75) Inventors: RAJESH GUNNALAN, SAMMAMISH, WA (US); HUMAYUN MUKHTAR KHAN, ISSAQUAH, WA (US)

(73) Assignee: MICROSOFT CORPORATION, REDMOND, WA (US)

(21) Appl. No.: 12/711,522

(22) Filed: Feb. 24, 2010

(51) Int. Cl. H04L 12/26

(52) U.S. Cl. 370/230.1

(57) ABSTRACT

A traffic shaper spaces out bursts of non-audio data traffic while allowing audio packets to be delivered in a more timely manner. The packets of bursts of non-audio packets are spaced such that audio packets are delivered at approximately the same spacing as before a burst of non-audio packets are submitted to be delivered. The packets for the non-audio data packets are scheduled based on the currently available bandwidth.

### BACKGROUND

Different types of applications send different types of media over the Internet. For example, many applications stream audio and video to clients. On high bandwidth links, the multimedia streams are typically smoothly presented to a user whereas low bandwidth links may result in a choppy presentation resulting in a degraded user experience.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A traffic shaper spaces out bursts of non-audio data traffic while allowing audio packets to be delivered in a more timely manner. The packets of the bursts of non-audio packets are spaced such that audio packets are delivered at approximately the same spacing as before a burst of non-audio packets are submitted to be delivered. The packets for the non-audio data packets are scheduled based on the currently available bandwidth.

### BRIEF DESCRIPTION OF THE DRAWINGS

FIG. 1 illustrates an exemplary computing device;

FIG. 2 shows a traffic shaping system;

FIG. 3 shows examples of multimedia being sent with and without processing by a traffic shaper;

FIG. 4 shows an illustrative process for receiving audio and non-audio data packets; and

FIG. 5 shows a process for shaping and scheduling non-audio packets for delivery.

### DETAILED DESCRIPTION

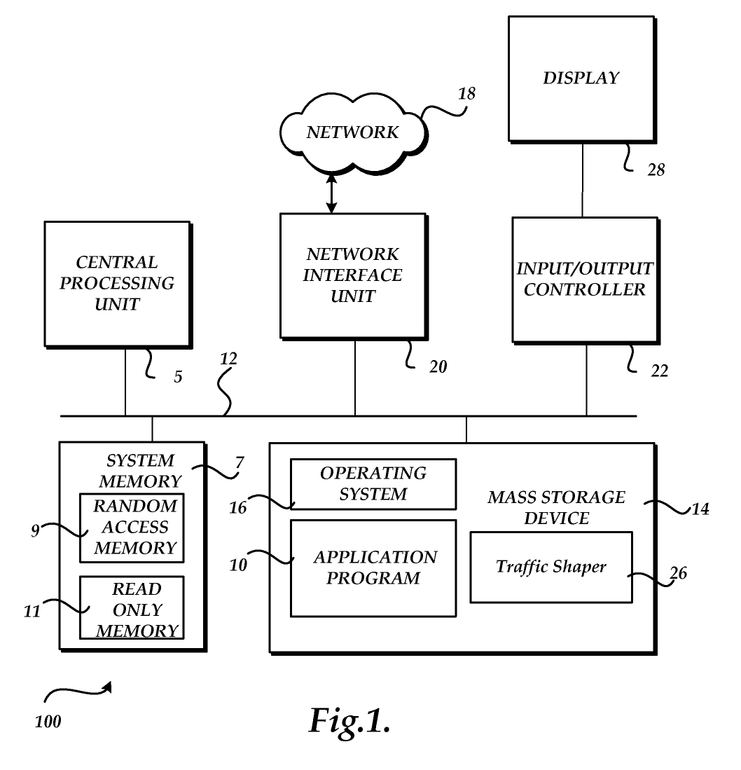

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop or mobile computer and includes a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 100 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen 28, a printer, or other type of output device.

As mentioned briefly above, a number of program modules and data files may be stored in the mass storage device 14 and RAM 9 of the computer 100, including an operating system 16 suitable for controlling the operation of a networked personal computer, such as the WINDOWS 7® operating system from MICROSOFT CORPORATION of Redmond, Wash. The mass storage device 14 and RAM 9 may also store one or more program modules. In particular, the mass storage device 14 and the RAM 9 may store an application program 10. The application program 10 may be many types of applications, such as an application that interacts with and sends audio and non-audio data. For example, application program 10 may be a communications application, such as MICROSOFTS OFFICE COMMUNICATOR, a multimedia application that is configured to deliver audio and video and other types of data streams, and the like. Other application programs that deliver media streams may also be used. For instance, email programs, desktop publishing programs, presentation programs, and any other type of program that provides multimedia streaming may be utilized.

Although traffic shaper 26 is shown separate from application program 10, it may be included within application program 10. As will be described in greater detail below, traffic shaper 26 is configured to space out bursts of non-audio data traffic such that the delivery of audio traffic is delivered in a more timely manner. The packets of bursts of non-audio packets are spaced such that audio packets are delivered at approximately the same spacing as before a burst of non-audio packets are submitted to be delivered.

Traffic shaper 26 determines the currently available bandwidth and uses the bandwidth information in scheduling delivery of the non-audio data packets.

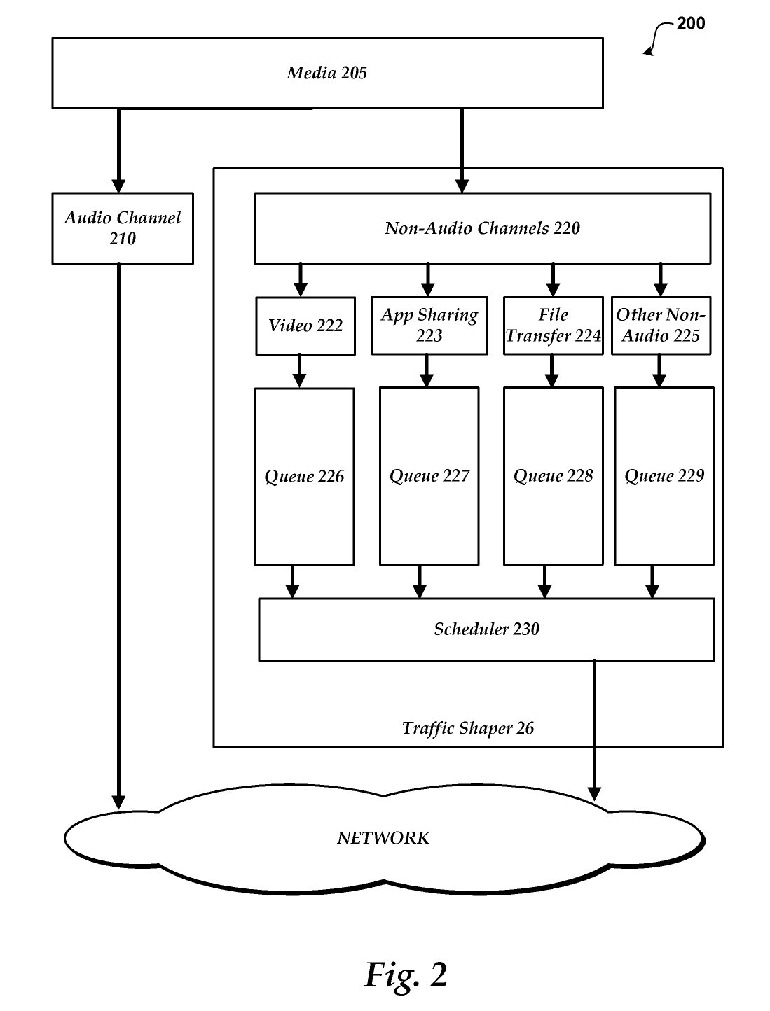

FIG. 2 shows a traffic shaping system 200. As illustrated, traffic shaping system 200 includes media 205, audio channel 210 and traffic shaper 26 that comprises non-audio channels 220, video data 222, app sharing data 223, file transfer data 224, other non-audio data 225, queues 226-229, and scheduler 230.

Traffic shaper 26 is configured to assist in helping to alleviate the degradation in audio quality that can be caused by bursts of non-audio packets (e.g. video I Frames and other data traffic). For example, on low bandwidth links such as DSL, video I Frames and other bursts of non-audio packets can adversely affect audio quality. When audio packets are delivered with a jitter (i.e., the inter packet gap between the delivery of audio packets is not kept approximately constant), the audio quality is degraded.

Generally, traffic shaper 26 intercepts non-audio data packets from media 205 and spaces out the delivery of the non-audio packets such that they are interleaved with the delivery of the packets in audio channel 210 instead of being delivered as received. Traffic shaper 26 spaces out the non-audio data packets such that the audio packet delivery interval does not significantly increase. For example, if audio is being delivered at approximately 20 millisecond intervals, then the non-audio data will be spaced such that the 20 millisecond intervals may be maintained.

As illustrated, the non-audio channels of media 205 flow through traffic shaper 26. There may be many different types of non-audio data packets that may be shaped by traffic shaper 26. For example, there may be video data 222, application sharing data 223, file transfer data 224 as well as other non-audio types of data 225. The traffic shaper 26 may be configured to avoid shaping some types of non-audio data packets. For example, according to one embodiment, Real-time Transport Control Protocol (RTCP) and Interactive Connectivity Establishment (ICE) packets are not processed by the traffic shaper. Delaying RTCP packets can impact bandwidth estimation and delaying ICE packets can potentially increase call setup delay. Other types of non-audio packets may also be excluded from being shaped by traffic shaper 26.

According to one embodiment, the audio packets in audio channel 210 bypass traffic shaper 26 and flow directly onto the network. According to another embodiment, the audio packets could flow through traffic shaper 26 without being processed by traffic shaper 26.

Each non-audio channel that is processed by traffic shaper 26 has an associated queue (226-229) in traffic shaper 26. According to one embodiment, sockets being used to send the non-audio packets register with traffic shaper 26 and upon registering a queue is created for the non-audio channel. When traffic shaper 26 receives non-audio data from a registered socket, the appropriate queue is selected to temporarily store the non-audio data packets. As the non-audio packets arrive, they are placed into the appropriate queue for delivery at a scheduled time. Scheduler 230 schedules the packets in the queues for delivery based on the available bandwidth. According to one embodiment, the non-audio data is processed by traffic shaper 26 periodically at pre-determined durations (e.g. 20 ms) or some other preconfigured value.

Scheduler 230 computes the amount of packets that may be delivered from one or more of the queues of traffic shaper 26 for each predetermined time duration. For example, scheduler 230 may determine a send budget per tick by calculating the currently available bandwidth and determining a total number of bytes that can be sent for the predetermined duration. Non-audio data may be selected for delivery using many different methods. For example, the different types of non-audio data may be prioritized according to importance (e.g. video before file transfer data), the oldest non-audio data in the queues may be delivered, and the like. According to one embodiment, traffic shaper 26 identifies the queue having the oldest last processed time stamp with data and processes it. If the selected queue has enough non-audio data for using up the send budget, the processing for the time duration is complete and the last processed time stamp is updated. If there is an amount of send budget remaining after processing the non-audio data in the selected queue, one or more subsequent queues that are ready to send non-audio data are processed until the budget for the time duration is used up or there are no queues with non-audio data ready to be processed. According to one embodiment, when there is excess budget available for a time duration, the excess is carried over as residue for subsequent time durations for processing the queues. This is done to help drain the queues while effectively utilizing the available bandwidth. If the queues are empty then any residual bandwidth available is reset. Resetting the residual bandwidth to zero helps to avoid accumulation of a large send budget.

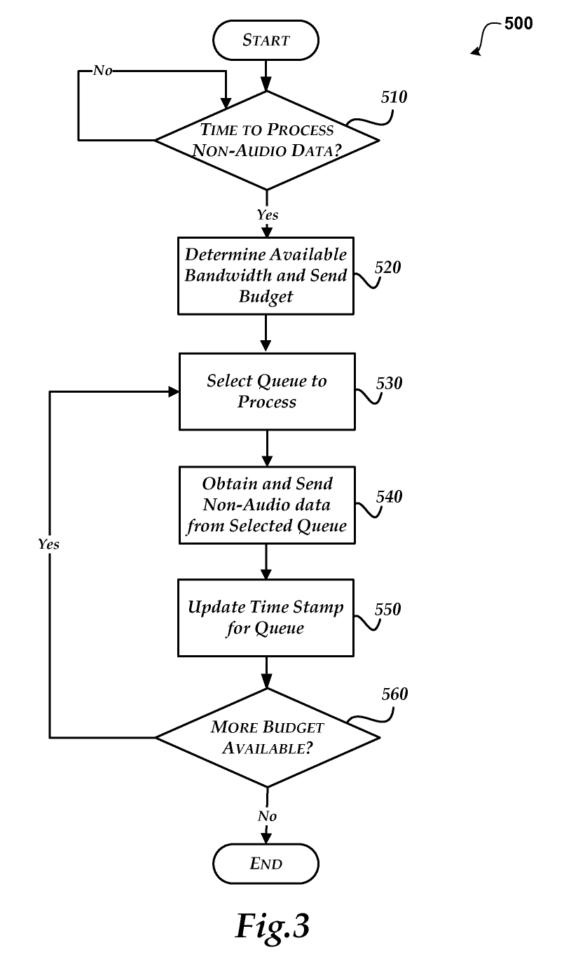

FIG. 3 shows examples of multimedia being sent with and without processing by a traffic shaper.

As illustrated, example 310 shows audio packets being sent at approximately 20 millisecond intervals. Generally, when audio is delivered at approximately 20 millisecond intervals, the audio quality is acceptable for a user.

Example 315 illustrates where a burst on non-audio packets is sent between two audio packets. In example 315, no traffic shaper is used to smooth out the burst on non-audio data packets, and as a result, the spacing of the audio packets is approximately 100 milliseconds. At 100 millisecond spacing, there is a degradation of the audio quality that is noticeable by the user.

Example 320 illustrates using a traffic shaper to space the non-audio data packets such that the audio packets are delivered at a predetermined interval. In example 320, the interval is approximately 20 milliseconds. Other intervals may be used (e.g. 5 ms, 10 ms, 15 ms, 25 ms, and the like).

Example 325 illustrates that even though a portion of the non-audio data packets were delayed from being sent as delivered to the traffic shaper, the non-audio data was received in approximately the same time frame as in example 315.

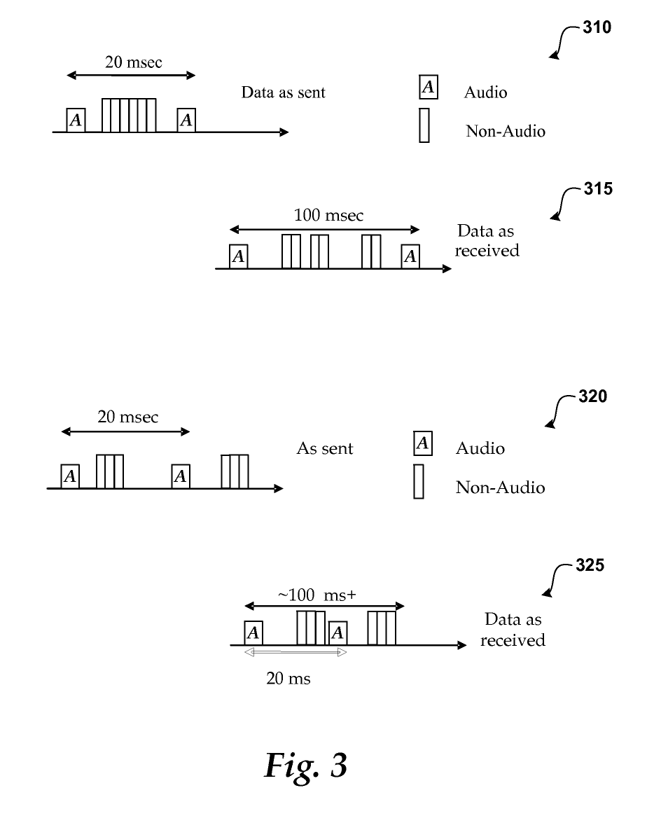

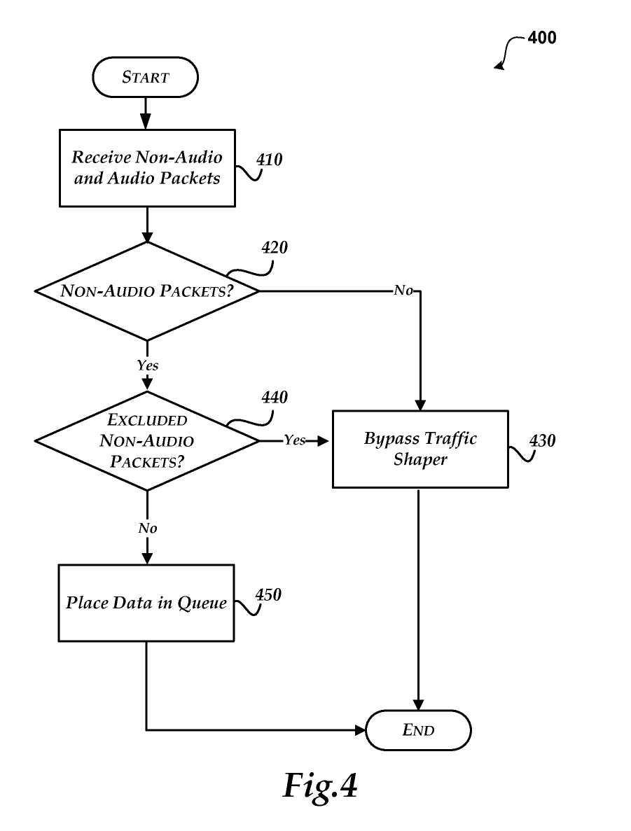

Referring now to FIGS. 4 and 5, an illustrative process for traffic shaping non-audio data streams will be described. Although the embodiments described herein are presented in the context of a traffic shaper 26 and a multimedia application program 10, other types of application programs that send audio and non-audio data streams may be utilized.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

Referring now to FIG. 4, a process for receiving audio and non-audio data packets will be described.

After a start operation, the process flows to operation 410, where non-audio and audio packets are received that are to be sent out for delivery. The types of packets received may be many different types of packets, including but not limited to: audio packets, video packets, application sharing packets, file transfer packets, other data packets, RTP packets, RTPC packets, ICE packets, and the like.

Moving to decision operation 420, a determination is made as to whether the packets received to be sent are non-audio packets. When the packets are audio packets, then the process flows to operation 430. When the packets are non-audio data packets, the process moves to decision operation 440.

At decision operation 440, a determination is made as to whether to exclude the non-audio packets from processing by the traffic shaper. Different non-audio packets may be configured to not be processed by the traffic shaper. According to one embodiment, RTCP and ICE packets are excluded from processing. When the non-audio packets are to be excluded from processing, the process flows to operation 430 where the packets are not processed by the traffic shaper. When the packets are to be processed by the traffic shaper, the process moves to operation 450.

At operation 450, the non-audio data packets that are to be processed are placed into a queue for processing and delivery by the traffic shaper. According to one embodiment, each stream of data is associated with a different queue. For example, video is associated with one queue whereas application sharing data is associated with another queue. According to another embodiment, each application that sends data is associated with a different queue. For example a first application that sends media is associated with one queue and a second application that sends media is associated with a different queue.

The process then moves to an end block and returns to processing other actions.

FIG. 5 shows a process for shaping and scheduling non-audio packets for delivery.

After a start operation, the process flows to decision operation 510, where a determination is made as to whether it is time to process the non-audio data. According to one embodiment, the non-audio data is processed at predetermined time durations. The time duration may be specified by a user (e.g. 5 ms, 10 ms, 15 ms, 20 ms, 25 ms . . . ). Generally, the time duration is specified such that audio quality remains acceptable to an end user. According to one embodiment, the time duration is set to 20 ms. When it is not time to process the non-audio data, the process returns to operation 510. When it is time to process the non-audio data, the process moves to operation 520.

At operation 520, the currently available bandwidth and the send budget for the time duration is determined. The send budget is the amount of non-audio data that may be processed during the current time duration.

Flowing to operation 530, a queue is selected for processing. According to one embodiment, the queue that has not been processed for the longest time period that has non-audio data is selected for processing. The queue to process may be selected other ways. For example, some queues may have priority over other queues, some application specific queues may have priority over other queues, and the like.

Transitioning to operation 540, data from the selected queue is obtained and sent for delivery. The amount of data that is obtained from the selected queue is determined based on the available send budget.

Moving to operation 550, the time stamp for the selected queue is updated to reflect the processing of data from the queue.

Flowing to decision operation 560, a determination is made as to whether there is any remaining budget available for the current time duration. For example, the selected queue may only have contained a portion of the available send budget. When there is send budget remaining, the process returns to operation 530 where another queue is selected. When there is not any budget available, the process then moves to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for traffic shaping of non-audio data, comprising:
receiving media to be delivered, wherein the media comprises audio packets and non-audio packets;
intercepting the non-audio packets and spacing the non-audio packets for delivery based on an available bandwidth; and
delivering the audio packets as they are received for delivery.

2. The method of claim 1, further comprising determining a send budget for a predetermined time duration.

3. The method of claim 2, further comprising determining the available bandwidth for the predetermined time duration.

4. The method of claim 1, further comprising after receiving the non-audio packets, placing the non-audio packets into a queue before being delivered.

5. The method of claim 4, wherein placing the non-audio packets into the queue before delivery further comprises placing each different type of non-audio packet into a different queue.

6. The method of claim 5, further comprising selecting the queue to obtain non-audio data packets for delivery based on a time stamp and sending non-audio data packets from the selected queue.

7. The method of claim 1, further comprising excluding a portion of the intercepted non-audio data packets from the spacing; wherein the excluded portion comprise Real-time Transport Control Protocol (RTCP) packets and Interactive Connectivity Establishment (ICE) packets.

8. The method of claim 5, further comprising periodically processing non-audio data packets within at least on of the queues according to a predefined time duration.

9. The method of claim 2, further comprising obtaining non-audio data packets for delivery until the send budget is used.

10. A computer-readable storage medium having computer-executable instructions for traffic shaping of non-audio data, comprising:
delivering audio packets as they are received for delivery;
intercepting non-audio packets before delivery;
storing the intercepted non-audio packets;
determining when to send the intercepted non-audio packets; and
delivering the non-audio packets when determined.

11. The computer-readable storage medium of claim 10, further comprising determining a send budget for a predetermined time duration that is based on an available bandwidth.

12. The computer-readable storage medium of claim 10, wherein storing the non-audio packets comprises placing the non-audio data packets into different queues.

13. The computer-readable storage medium of claim 12, wherein determining when to send the intercepted non-audio packets comprises selecting one of the queues to obtain non-audio data packets for delivery based on a time stamp indicating when the queue was last processed and delivering the obtained non-audio data packets from the selected queue.

14. The computer-readable storage medium of claim 10, further comprising excluding a portion of the intercepted non-audio data packets from being stored and delivering the excluded portion as they are received for delivery.

15. The computer-readable storage medium of claim 12, further comprising periodically selecting one of the queues and obtaining the non-audio data packets within the selected queue according to a predefined time duration.

16. An apparatus for traffic shaping of non-audio data, comprising:
a processor and a computer-readable storage medium;
an operating environment stored on the computer-readable storage medium and executing on the processor;
a network interface unit coupled to a network;
a traffic shaper operating under the control of the operating environment and operative to perform actions, including:
intercepting non-audio packets; wherein audio packets bypass the traffic shaper;
storing the intercepted non-audio packets;
determining when to send the intercepted non-audio packets; and
delivering the non-audio packets when determined.

17. The apparatus of claim 16, further comprising determining a send budget for a predetermined time duration that is based on an available bandwidth.

18. The apparatus of claim 16, wherein storing the non-audio packets comprises placing the non-audio data packets into different queues based on a type of non-audio data packet intercepted.

19. The apparatus of claim 18, wherein determining when to send the intercepted non-audio packets comprises selecting one of the queues to obtain non-audio data packets for delivery based on a time stamp indicating when the queue was last processed and delivering the obtained non-audio data packets from the selected queue.

20. The apparatus of claim 16, further comprising excluding a portion of the intercepted non-audio data packets from being stored.
